(19) United States
(12) Patent Application Publication
(10) Pub. No.: US 2026/0145304 A1
(43) Pub. Date: May 28, 2026

(54) Modular Angled Clamp Assemblies

(71) Applicant: FIREBALL TOOL WORKS LLC, Spokane, WA (US)

(72) Inventors: Elliott Ian Wong, Alhambra, CA (US); Jason A. Marburger, Spokane, WA (US)

(73) Assignee: FIREBALL TOOL WORKS LLC, Spokane, WA (US)

(21) Appl. No.: 18/961,428

(22) Filed: Nov. 26, 2024

(51) Int. Cl. B25B 5/16; B25B 5/00

(52) U.S. Cl. CPC B25B 5/163; B25B 5/006

(57) ABSTRACT

Modular angled clamp assemblies and components are described. In an example, an angled clamp assembly includes one or more of a clamp component, an interface member, and a support member. The interface member includes a first bend disposed between a proximal end and a distal end of the interface member and the support member includes a second bend disposed between a proximal end and a distal end of the support member. The proximal end of the interface member includes a clamp mounting interface to adjustably connect the clamp component. The proximal end of the support member includes a slidable mounting interface to adjustably attach to the interface component. The clamp component, interface member, and support member can be configured in a variety of orientations and positions by leveraging the first bend and second bend to achieve a variety of working scenarios.

### BACKGROUND

Clamps are often used to secure one or more workpieces to a surface or to one another, such as to provide stability and support for various applications such as construction, welding, woodworking, etc. Accordingly, a wide range of clamp designs exist to accommodate different materials and use cases, such as clamps with varied materials, geometries, sizes, form factors, etc. Table clamps, for instance, can be arranged on a gridded worktable that includes a grid of holes via pins or studs that attempt to position the table clamp adjacent to a particular workpiece to secure the particular workpiece. Conventional table clamps, however, often exhibit limited angular adjustment and have a limited range of motion, which can significantly restrict utility of such table clamps. Further, conventional table clamps have a bulky and cumbersome design that includes components that obstruct a workspace and can interfere with a user attempting to apply work to a particular workpiece. Accordingly, it is often difficult and time consuming for users to controllably affix workpieces in a desired orientation or position to apply work to the workpieces.

### SUMMARY

Modular angled clamp assemblies and components are described that can be used in conjunction with or independent of a work surface such as a gridded worktable. An example angled clamp assembly includes an interface member, a support member, and a clamp member that are attachable to one another in a variety of configurations and/or orientations to achieve a variety of working scenarios and applications. For instance, the interface member includes a first bend with a first bend angle, and the support member includes a second bend with a second bend angle. The interface member and the support member are thus attachable to one another to achieve various orientations by leveraging the bend angles created by the first and second bend. The interface member further includes a clamp mounting interface to rotatably attach to the clamp member. In this way, a jaw of the clamp member can be positioned in a variety of positions and orientations to achieve a variety of different working scenarios that are not achievable using conventional table clamps.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 depicts a view of an example angled clamp assembly in accordance with one or more implementations described herein.

FIG. 2 depicts an additional view of the angled clamp assembly in accordance with one or more implementations.

FIG. 3 depicts an additional view of the angled clamp assembly in accordance with one or more implementations.

FIG. 4 depicts a view of the angled clamp assembly with various components of the angled clamp assembly disengaged from one another in accordance with one or more implementations.

FIG. 5 depicts a view of the clamp mounting interface of the angled clamp assembly in accordance with one or more implementations.

FIG. 6 depicts an example of the angled clamp assembly that illustrates functionality of a pivot component of the clamp mounting interface in accordance with one or more implementations.

FIG. 7 depicts a view of the angled clamp assembly in an example in which the clamp mounting interface includes a rotational component in accordance with one or more implementations.

FIG. 8 depicts an example of the angled clamp assembly in which the clamp member is reversible in accordance with one or more implementations.

FIG. 9 depicts an example of the angled clamp assembly in which the slidable mounting interface is adjusted in accordance with one or more implementations.

FIG. 10 depicts an example of the angled clamp assembly in which a position of a tail of the angled clamp assembly is adjusted in accordance with one or more implementations.

FIG. 11 depicts an example of the angled clamp assembly in which the angled clamp assembly is attached to a work surface in accordance with one or more implementations.

FIG. 12 depicts an example of the angled clamp assembly in which the interface member is insertable into a work surface in accordance with one or more implementations.

FIG. 13 depicts an example of the angled clamp assembly in which the angled clamp assembly is operable to affix work pieces to one another in accordance with one or more implementations.

FIGS. 14a and 14b depict an example of the angled clamp assembly in which the angled clamp assembly is insertable into a side aperture of a work surface in accordance with one or more implementations.

FIGS. 15a and 15b depict an example of the angled clamp assembly in which the angled clamp assembly is insertable into a side aperture of a work surface in accordance with one or more implementations.

### DETAILED DESCRIPTION

### Overview

Modular angled clamp components and assemblies are described. In an example implementation, an angled clamp assembly includes one or more of a clamp member, an interface member, and a support member. The interface member, for instance, includes a first bend having a first bend angle disposed between a proximal end and a distal end of the interface member. Accordingly, the interface member includes a proximal region between the first bend and the proximal end and a distal region between the first bend and the distal end.

The support member includes a second bend having a second bend angle disposed between a proximal end and a distal end of the support member. The support member also includes a proximal region between the second bend and the proximal end and a distal region between the second bend and the distal end. In at least one example, the first bend angle and the second bend angle are 45 degrees, however this is by way of example and not limitation and a variety of bend angles are considered.

The proximal end of the support member includes a slidable mounting interface that is attachable to the interface component. The slidable mounting interface, for instance, supports attachment of the support member to the distal region of the interface member such that the support member is movable along a longitudinal axis of the distal region of the interface member. The slidable mounting interface may further enable rotation of the support member and/or the interface member, such as about the longitudinal axis of the distal region of the interface member.

In various embodiments, the slidable mounting interface is reversible such that the support member can be attached to the interface member in a variety of configurations. For instance, the support member can be attached to the interface member via the slidable mounting interface in a first orientation. In the first orientation, the longitudinal axis of the distal region of the interface member forms an obtuse interior angle with a longitudinal axis of the distal region of the support member. The support member can also be attached to the interface member via the slidable mounting interface in a second orientation such that the longitudinal axis of the distal region of the interface member forms an acute interior angle with the longitudinal axis of the distal region of the support member.

The proximal end of the interface member further includes a clamp mounting interface that can attach the clamp member to the interface member. In various examples, the clamp mounting interface includes a pivot component and/or a rotational component. The pivot component, for instance, supports rotation of the clamp member about the pivot component in a plane that includes a longitudinal axis of the proximal region of the interface member. The rotational component supports rotation of the clamp member, such as about the longitudinal axis of the proximal region of the interface member.

In this way, the angled clamp assembly enables a variety of configurations and orientations. For instance, the first bend and the second bend can be aligned and positioned with respect to one another in various ways to create a variety of spatial arrangements and/or configurations. Further, by adjusting the rotational alignment between one or more components of the angled clamp assembly, the angled clamp assembly can be positioned in precise orientations and configurations suited to specific applications. In this way, the techniques described herein support efficient and versatile implementation of clamp components to secure workpieces in a variety of orientation and configurations and thus achieve a variety of different working scenarios.

Accordingly, the described modular angled clamp assemblies provide for a multitude of configurations and workpiece arrangements not provided by conventional tools for securing workpieces. In the following discussion, example angled clamp components and assemblies are described that may employ the techniques described herein. Example scenarios are also described in which the example angled clamp components and assemblies are utilized. The example angled clamp components and assemblies are not limited to performance of the example scenarios.

### Modular Angled Clamp Assemblies

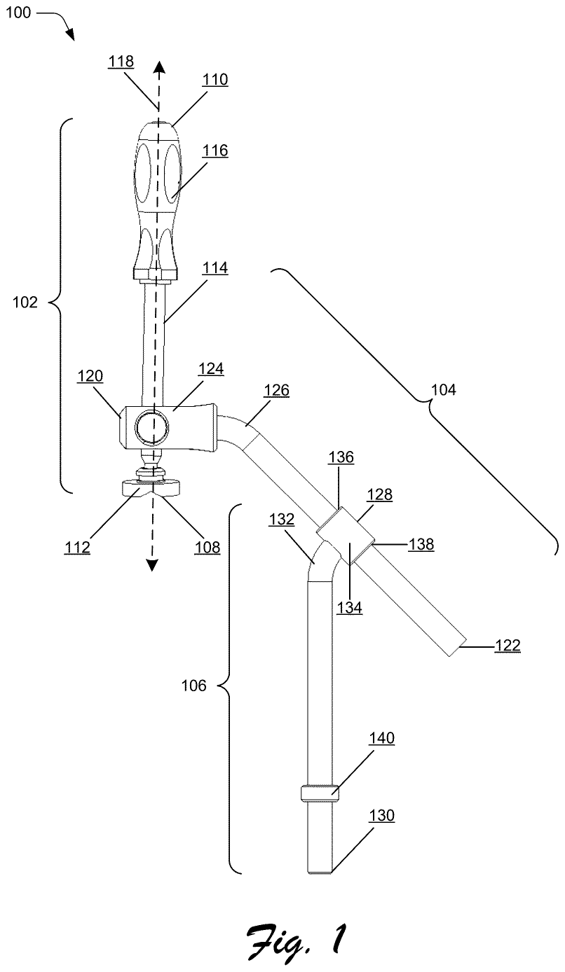

FIGS. 1-15b depict various attributes of example angled clamp components and assemblies that are operable to employ techniques described herein. FIG. 1 depicts a view of an example angled clamp assembly 100 in accordance with one or more implementations described herein. In the illustrated example, the angled clamp assembly 100 includes a clamp member 102, an interface member 104, and a support member 106 that are attached to one another in a particular configuration. As further described in the following examples and shown in corresponding figures, the angled clamp components provide for various configurations to achieve a variety of working scenarios.

The clamp member 102 includes a proximal end 108 and a distal end 110. The proximal end 108 includes a jaw 112. In the illustrated example, the jaw 112 is a movable jaw that is connected to a spindle 114 of the clamp member 102 such as via a movable ball joint. The movable ball joint, for instance, enables the jaw to pivot and adjust an angle of the jaw in relation to effectively contact a workpiece, such as to secure the workpiece to an adjacent surface.

This is by way of example and not limitation, and a variety of styles, types, and/or features of jaw 112 are considered. In at least one example, the jaw 112 is a fixed jaw, e.g., secured in a particular orientation. In various embodiments, the jaw 112 includes one or more of a swiveled jaw, a soft/flexible jaw, grooves and/or serrations. The jaw 112 can further include a shaped contact surface, such as to secure irregular shaped workpieces. For instance, the jaw 112 includes a curved contact surface to contact a rounded workpiece such as a pipe or rod.

The distal end 110 includes an actuation component 116. The actuation component 116 is operable to control a relative position of the jaw 112 along a longitudinal axis 118 of the clamp member 102, such as to adjust a position of the clamp member 102 along the longitudinal axis 118 with respect to the interface member 104. In the illustrated example, the actuation component 116 includes an ergonomic handle, such that rotation of the actuation component 116 about the longitudinal axis 118 in a first direction (e.g., clockwise) causes a first direction of movement while rotation of the actuation component 116 in a second direction causes a second direction of the motion of the clamp member 102. This is by way of example and not limitation, and the actuation component 116 can include one or more of a lever arm, knob, wing nut, screw mechanism, ratchet mechanism, slide lock, sliding pin handle, etc.

The clamp member 102 is further interchangeable with a variety of clamp components and/or apparatuses. In various embodiments, the clamp member 102 includes one or more of a pneumatic clamp, pipe clamp, parallel clamp, corner clamp, pliers clamp, etc. In this way, the apparatuses and techniques described herein are customizable for a variety of applications and working scenarios.

The interface member 104 includes a proximal end 120 and a distal end 122. The proximal end 120 of the interface member 104 includes a clamp mounting interface 124. Generally, the clamp mounting interface 124 is configured to attach the clamp member 102 to the interface member 104. As further described in more detail below, in some examples the clamp mounting interface 124 includes one or more components (e.g., a pivot component and/or a rotational component) that support movement of the of the clamp member 102 in one or more directions and/or along one or more axes, while restricting movement of the clamp member 102 in one or more directions and/or along one or more axes.

The interface member 104 further includes a first bend 126 disposed between the distal end 122 and the proximal end 120. The first bend 126 can be disposed at a variety of positions between the distal end 122 and the proximal end 120. The first bend 126 is defined by a bend angle, e.g., how sharply the interface member 104 curves. The bend angle, for instance, represents a deflection of the interface member 104 from a neutral axis. In at least one example, the first bend 126 has a bend angle in a range of 40 degrees to 50 degrees, e.g., a 45-degree bend angle.

This is by way of example and not limitation, and a variety of properties of the first bend 126 are considered. For instance, the bend angle can be in a range of zero degrees to 180 degrees. The first bend 126 is further defined by a bend radius that defines how “tight” or “gradual” the first bend 126 is. The bend radius, for instance, represents a distance from a center of a curvature of the first bend 126 to a neutral axis of the interface member 104.

A relatively small bend radius indicates a relatively tight bend, while a relatively large bend radius indicates a relatively gradual bend. In some examples, the bend radius is defined with relation to a diameter and/or width of the interface member 104. For instance, the bend radius can range from a fraction of the diameter of the interface member 104 for a tight bend (e.g., less than one times the diameter) to a gradual bend with a bend radius multiple times the diameter, e.g., greater than ten times the diameter. In at least one example, the bend radius of the first bend 126 is in a range of 1D, e.g., one times the diameter, to 5D, e.g., five times the diameter.

The support member 106 includes a proximal end 128, a distal end 130, and a second bend 132 disposed between the proximal end 128 and the distal end 130. As described above with respect to the first bend 126, the second bend 132 can include a variety of properties, such as a position between the proximal end 128 and the distal end 130, a bend angle, a bend radius, etc. The second bend 132 may share one or more properties with the first bend 126 and/or include one or more different properties than the first bend 126. In at least one example, the second bend 132 has a bend angle in a range of 40 degrees to 50 degrees, e.g., a 45-degree bend angle, and a bend radius in a range of 1D, e.g., one times a diameter of the support member 106, to 5D, e.g., five times the diameter.

The proximal end 128 of the support member 106 includes a slidable mounting interface 134. Generally, the slidable mounting interface 134 is configured to adjustably attach the support member 106 to the interface member 104. For instance, the slidable mounting interface 134 enables the support member 106 to slide along a length of one or more portions of the interface member 104. The slidable mounting interface 134 can further be configured to support rotation of the support member 106, such as about a longitudinal axis of one or more portions of the interface member 104.

In at least one example, the slidable mounting interface 134 includes one or more apertures that are dimensioned to coincide with a cross-section of the interface member 104. For instance, the interface member 104 is a cylinder that includes a circular cross-section and the slidable mounting interface 134 includes a sleeve/tube defined by one or more apertures configured to fit concentrically around the interface member 104. For instance, the tube portion of the slidable mounting interface 134 includes an inner diameter slightly larger than the outer diameter of the interface member 104 to enable a secure and adjustable fit.

In the illustrated example, the slidable mounting interface 134 includes an outer aperture 136 and an inner aperture 138. The outer aperture 136, for instance, is located on a portion of slidable mounting interface 134 adjacent to an outer surface (e.g., an outer radius) of the second bend 132. The inner aperture 138, for instance, is located on a portion of the slidable mounting interface 134 adjacent to an inner surface (e.g., an inner radius) of the second bend 132.

In at least one example, the slidable mounting interface 134 includes at least one additional set of apertures through which the distal end 122 is insertable. For instance, the slidable mounting interface 134 includes a second set of apertures perpendicular from a first set of apertures, e.g., the outer aperture 136 and the inner aperture 138. The second set of apertures thus expands a number of possible configurations of the angled clamp assembly 100.

The slidable mounting interface 134 may further include one or more flanges, grooves, and/or threads such as to enhance grip and/or alignment with the interface member 104. By way of example, the interface member 104 includes one or more grooves that extend from the distal end 122 to the first bend 126. The slidable mounting interface 134 includes one or more protrusions dimensioned to coincide with the one or more grooves, such as to prevent unwanted rotation of the support member 106 with respect to the interface member 104.

In various examples, the slidable mounting interface 134 includes one or more fastening mechanisms (e.g., clamps, screws, adhesive elements, locking spring pins, etc.) such as to lock the support member 106 in one or more orientations and/or positions with respect to the interface member 104. For instance, the interface member 104 includes one or more perpendicular apertures and the slidable mounting interface 134 includes one or more locking spring pins configured to engage with the one or more perpendicular apertures. In this way, the slidable mounting interface 134 can affix the support member 106 to the clamp member 102 at a desired position along a length of the interface member 104 and/or at a desired rotational orientation with respect to a longitudinal axis of the interface member 104.

In various examples, the slidable mounting interface 134 is reversible such that the support member 106 is attachable to the interface member 104 in a variety of orientations. For instance, as depicted the slidable mounting interface 134 attaches the support member 106 to the interface member 104 in a first orientation with the outer aperture 136 adjacent to the first bend 126, e.g., a distance between the outer aperture 136 and the first bend 126 is shorter than a distance between the inner aperture 138 and the first bend 126. This provides a particular configuration, e.g., a first configuration, of the angled clamp assembly 100.

The slidable mounting interface 134 can be reversed to attach the support member 106 to the interface member 104 in a second orientation to achieve a second configuration of the angled clamp assembly 100. For instance, the support member 106 can be removed from the interface member 104, rotated 180 degrees, and attached to the interface member 104 by inserting the distal end 122 through the inner aperture 138. In the second configuration, the inner aperture 138 is closer to the first bend 126 than the outer aperture 136. In this way, the interface member 104 and the support member 106 are attachable to one another to achieve a variety of configurations and orientations by leveraging the bend angles created by the first bend 126 and the second bend 132.

In various examples, the support member 106 further includes a collar 140. The collar 140, for instance, facilitates attachment of the angled clamp assembly 100 to an adjacent surface such as a gridded worktable. For example, the distal end 130 of the support member 106 is dimensioned to coincide with an aperture of the gridded worktable, and the collar 140 has a circumference greater than a circumference of the aperture. Accordingly, the collar 140 controls a relative depth that the support member 106 is insertable into the aperture.

In various embodiments, the collar 140 is adjustable and/or removable such that the collar 140 can be positioned at variable locations along a length of the support member 106. For example, the collar 140 can be moved along a length of the support member 106 to adjust a depth at which the support member 106 is inserted into an aperture. In at least one example, the support member 106 includes a threaded region and the collar 140 includes corresponding threads such that a position of the collar 140 with respect to the support member 106 can be adjusted by rotating the collar 140 and causing the respective threads to engage with one another. In this way, adjustment of the collar 140 can control a relative position of the jaw 112, such as with respect to a workpiece and/or along the longitudinal axis 118. This is by way of example and not limitation and a variety of suitable attachment mechanisms of the collar 140 to the support member 106 are considered.

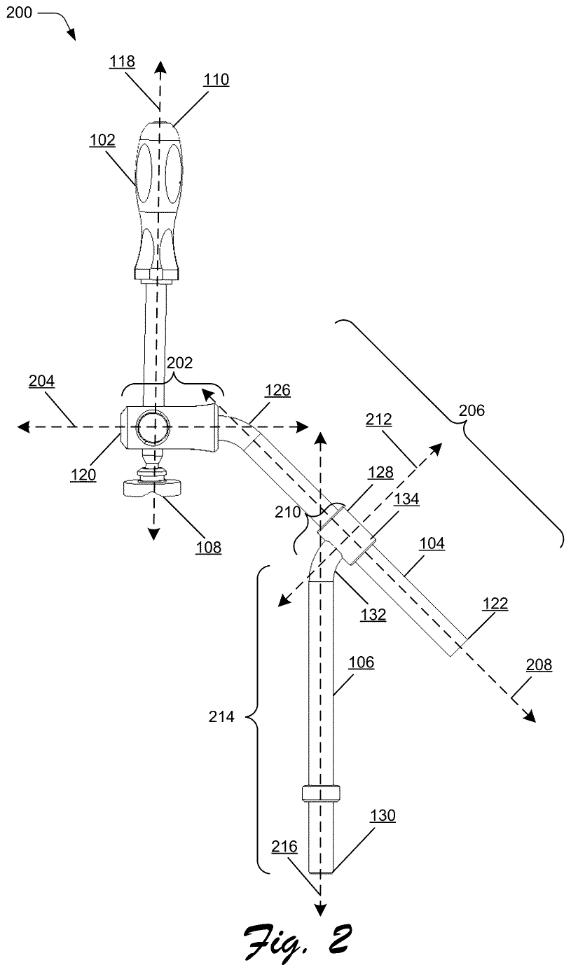

FIG. 2 depicts an additional view 200 of the angled clamp assembly 100 in accordance with one or more implementations. In this example, the interface member 104 includes a proximal region 202 disposed between the proximal end 120 and the first bend 126. The proximal region 202 includes a longitudinal axis 204, for instance, that extends along a length of the proximal region 202 through the first bend 126 and the proximal end 120.

The interface member 104 further includes a distal region 206 disposed between the first bend 126 and the distal end 122. The distal region 206 includes a longitudinal axis 208, for instance, that extends along a length of the distal region 206 through the first bend 126 and the distal end 122. Accordingly, the first bend 126 has a bend angle that is represented by a deviation between the longitudinal axis 204 and the longitudinal axis 208. By way of example and not limitation, an angle between the longitudinal axis 208 and the longitudinal axis 204 is 135 degrees, and accordingly the bend angle of the first bend 126 is 45 degrees.

In at least one example, the first bend 126 includes an angular adjustment component operable to change a bend angle of the first bend 126. A variety of angular adjustment components are considered, such as one or more hinges, swivel joints, bearing mechanisms, lockable washers, gears, lockable elements, etc. The angular adjustment component, for instance enables rotation of the proximal region 202 relative to the distal region 206. The angular adjustment component is further operable to affix the proximal region 202 at one or more rotational orientations, such as to “lock” the proximal region 202 at a particular bend angle with respect to the distal region 206.

The support member 106 also includes a proximal region 210 disposed between the second bend 132 and the proximal end 128. The proximal region 210 includes a longitudinal axis 212 that extends along a length of the proximal region 210 through the second bend 132 and the proximal end 128. The support member 106 includes a distal region 214 between the second bend 132 and the distal end 130. The distal region 214 includes a longitudinal axis 216 that extends along a length of the distal region 214 through the second bend 132 and the distal end 130. Accordingly, the second bend 132 has a bend angle that is represented by a deviation between the longitudinal axis 212 and the longitudinal axis 216.

In at least one example, the second bend 132 includes an angular adjustment component operable to adjust a bend angle of the second bend 132. As described above with respect to the first bend 126, a variety of angular adjustment components are considered, such as one or more hinges, swivel joints, bearing mechanisms, lockable washers, gears, lockable elements, etc. The angular adjustment component, for instance enables rotation of the proximal region 210 relative to the distal region 214. The angular adjustment component is further operable to affix the proximal region 210 at one or more rotational orientations, such as to “lock” the proximal region 210 at a particular angle with respect to the distal region 214.

In the illustrated example, the distal region 206 is depicted as relatively longer than the proximal region 202 and the distal region 214 is depicted as relatively longer than the proximal region 210. This is by way of example and not limitation, and a variety of region lengths are considered. For instance, the first bend 126 can be located at any suitable location between the proximal end 120 and the distal end 122 and the second bend 132 can be located at any suitable location between the proximal end 128 and the distal end 130. In at least one example, one or more of the proximal region 202, the distal region 206, the proximal region 210, and/or the distal region 214 have a substantially similar length.

In this example, the angled clamp assembly 100 is disposed in a particular configuration, e.g., a first configuration. For instance, a first orientation of the clamp member 102 causes the outer aperture 136 of the second bend 132 to be relatively proximal to the first bend 126 and the inner aperture 138 to be relatively proximal to the distal end 122. In this orientation, the longitudinal axis 212 is substantially perpendicular to the longitudinal axis 208.

Further, the longitudinal axis 216 and the longitudinal axis 208 intersect to form an obtuse interior angle. The support member 106 has a rotational orientation such that the longitudinal axis 204 is substantially perpendicular to the longitudinal axis 216. The clamp member 102 is also positioned such that the longitudinal axis 118 is substantially parallel to the longitudinal axis 216 and substantially perpendicular to the longitudinal axis 204.

As described above, a variety of the components and/or features of the angled clamp assembly 100 provide for a multitude of configurations and/or orientations. For instance, in one or more examples the clamp member 102 is adjustable and/or reversible, the clamp mounting interface 124 includes one or more components to pivot and/or rotate the clamp member 102, the interface member 104 can be rotated within the slidable mounting interface 134, the slidable mounting interface 134 is adjustable and/or reversible, the first bend 126 and/or the second bend 132 have variable properties, etc. Thus, in various embodiments the longitudinal axis 118, longitudinal axis 204, longitudinal axis 208, the longitudinal axis 212, and/or the longitudinal axis 216 are disposed at a variety of positions and/or angles with respect to one another.

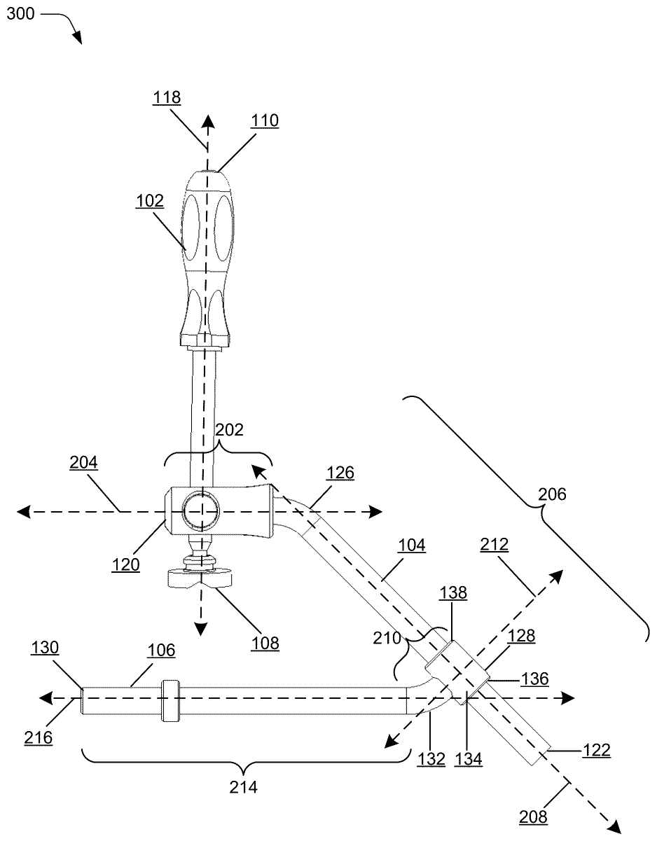

FIG. 3 depicts an additional view 300 of the angled clamp assembly 100 in accordance with one or more implementations. In this example, the support member 106 is attached to the interface member 104 in a second orientation to achieve a particular configuration, e.g., a second configuration, of the angled clamp assembly 100. For instance, the distal end 122 of the interface member 104 is inserted through the inner aperture 138 of the slidable mounting interface 134 to adjustably attach the support member 106 to the interface member 104. Accordingly, the inner aperture 138 is adjacent to the first bend 126 and the outer aperture 136 is adjacent to the distal end 122.

In this particular configuration of the angled clamp assembly 100, the longitudinal axis 212 is substantially perpendicular to the longitudinal axis 208 such as because of the bend angle of the first bend 126 and/or the second bend 132. Further, the interface member 104 is oriented such that the longitudinal axis 216 and the longitudinal axis 208 intersect to form an acute interior angle. The interface member 104 has a rotational orientation such that the longitudinal axis 204 is substantially parallel to the longitudinal axis 216. The clamp member 102 is also positioned such that the longitudinal axis 118 of the clamp member 102 is substantially perpendicular to the longitudinal axis 204 as well as the longitudinal axis 216.

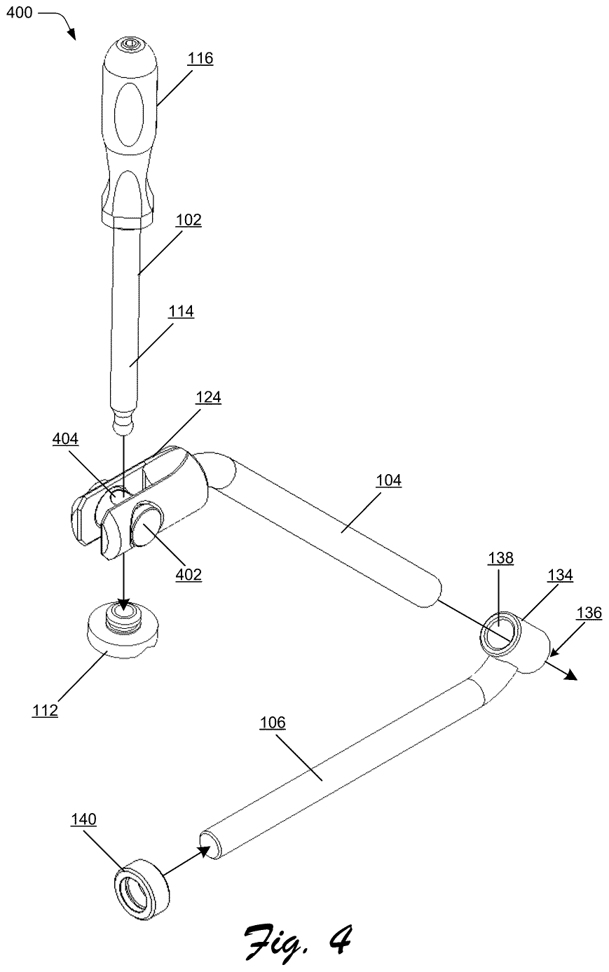

FIG. 4 depicts a view 400 of the angled clamp assembly 100 with various components of the angled clamp assembly 100 disengaged from one another in accordance with one or more implementations. As depicted, the clamp member 102, the interface member 104, and the support member 106 are disengaged from one another. The collar 140 is depicted as disengaged from the slidable mounting interface 134 and the jaw 112 is depicted as disengaged from the spindle 114 of the clamp member 102.

As described above, the collar 140 is removable from the support member 106. The collar 140 is attachable to the support member 106 in a variety of ways, such as one or more of a threaded connection, magnetic interface, friction components and/or inserts, compression fitting, lever/cam lock, spring pin, magnets, etc. Thus, the collar 140 can be positioned at a variety of locations along the support member 106.

As described above and shown in the following examples, the support member 106 is attachable to the interface member 104 via the slidable mounting interface 134, such as by insertion of the interface member 104 through either end of the slidable mounting interface 134, e.g., through the outer aperture 136 and/or the inner aperture 138. In the illustrated example, for instance, the interface member 104 is aligned to be inserted through the inner aperture 138 of the slidable mounting interface 134 first to attach to the support member 106 in a particular orientation to achieve a particular configuration of the angled clamp assembly 100, such as the second configuration discussed above with respect to FIG. 3.

In the illustrated example, the jaw 112 is disengaged from the spindle 114. In various examples, one or more of the actuation component 116, spindle 114, and/or jaw 112 can be disengaged from one another such as to facilitate attachment to the clamp mounting interface 124. For instance, although not depicted in this example, the actuation component 116 can be removed from the spindle 114.

The clamp member 102 is attachable to the interface member 104 via the clamp mounting interface 124. In this example, the clamp mounting interface 124 includes a pivot component 402 that includes an aperture 404 dimensioned to coincide with the spindle 114. For instance, a diameter of the aperture 404 is slightly larger than a diameter of the spindle 114. Accordingly, the spindle 114 is insertable through the aperture 404 to secure the clamp member 102 to the interface member 104. The clamp mounting interface 124 further can include a variety of components to prohibit and/or enable controlled motion of the clamp member 102, such as shown in more detail in the following examples.

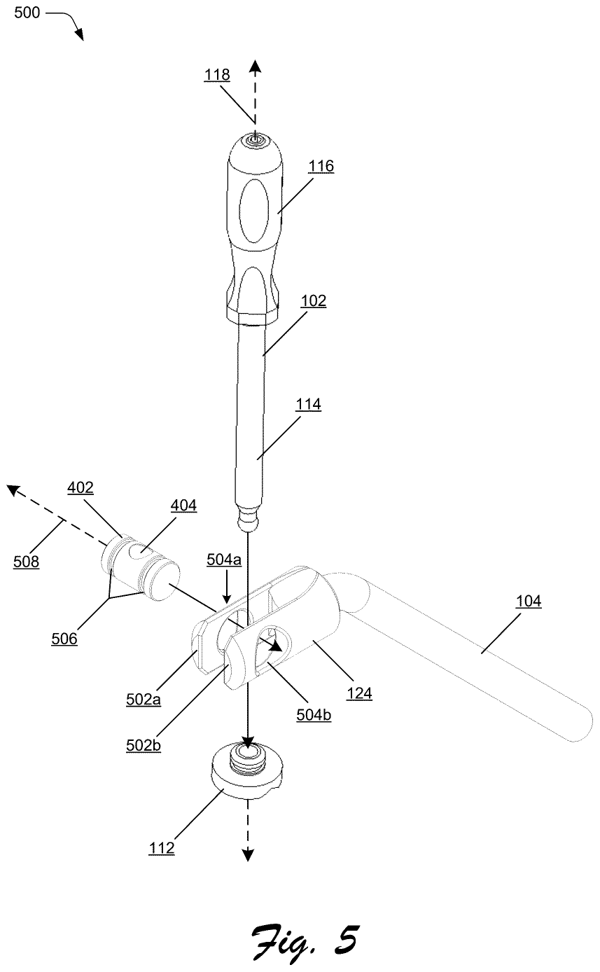

FIG. 5 depicts a view 500 of the clamp mounting interface 124 of the angled clamp assembly 100 in accordance with one or more implementations. In this example, the pivot component 402 is depicted as disengaged from the clamp mounting interface 124. The clamp mounting interface 124 includes one or more wings such as a first wing 502a and a second wing 502b. The first wing 502a and the second wing 502b each include a perpendicular aperture through which the pivot component 402 is insertable, such as a first aperture 504a and a second aperture 504b.

The pivot component 402 includes one or more circumferential grooves 506 that are dimensioned to align with the apertures 504a, 504b of the first wing 502a and the second wing 502b. Accordingly, the one or more circumferential grooves secure the pivot component 402 between the first wing 502a and the second wing 502b to attach the pivot component 402 to the clamp mounting interface 124. The one or more circumferential grooves 506 further enable rotation of the pivot component 402 once attached to the clamp mounting interface 124, such as about a longitudinal axis 508 of the pivot component 402. In an example, the clamp member 102 can rotate about the pivot component 402 in a plane that includes the longitudinal axis 204.

The clamp member 102 is attachable to the clamp mounting interface 124, such as via insertion of the spindle 114 through the aperture 404. The spindle 114 can further be attached to the jaw 112, e.g., once inserted through either side of the aperture 404. In various examples, the aperture 404 is a tapped aperture that includes a configuration of threads. The spindle 114 includes a threaded region with threads that correspond to the threads of the aperture 404. Accordingly, the clamp member 102 can be movably positioned within the aperture 404 such as by rotation of the actuation component 116 clockwise and/or counterclockwise to cause the threads to engage with one another and cause the clamp member 102 to move along the longitudinal axis 118.

In at least one example, the aperture 404 is bidirectional and/or reversible. For instance, the aperture 404 includes double-entry threads that correspond to the threaded region of the clamp member 102. Accordingly, the clamp member 102 can be inserted through either side of the aperture 404 and movably positioned by the double-entry threads in accordance with the techniques described herein. In this way, the techniques described herein provide additional configuration options for the clamp member 102 with relation to the interface member 104 and/or the support member 106 to support a variety of applications.

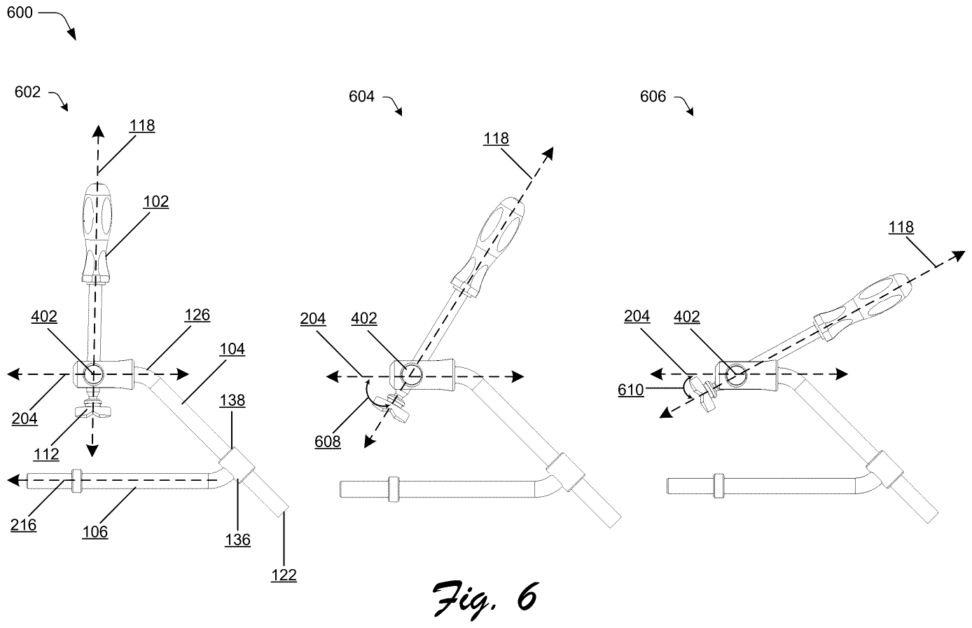

FIG. 6 depicts an example 600 of the angled clamp assembly 100 that illustrates functionality of a pivot component 402 of the clamp mounting interface 124 in a first stage 602, a second stage 604, and a third stage 606 in accordance with one or more implementations. In this example, the angled clamp assembly 100 is configured such that the inner aperture 138 is closer to the first bend 126 while the outer aperture 136 is closer to the distal end 122. The interface member 104 and the clamp member 102 are further oriented such that the jaw 112 faces the support member 106.

As shown in the first stage 602, the clamp member 102 is attached to the interface member 104 via the clamp mounting interface 124. The angled clamp assembly 100 is configured in a particular configuration, such as the configuration discussed above with respect to FIG. 3. Accordingly, the clamp member 102 is disposed such that the longitudinal axis 118 is substantially perpendicular to the longitudinal axis 204 as well as the longitudinal axis 216.

Progressing to the second stage 604, the clamp member 102 has been rotated about the pivot component 402, such as in a plane that includes the longitudinal axis 204. Accordingly, an angle 608 between the longitudinal axis 118 and the longitudinal axis 204 has changed upon rotation of the clamp member 102. As shown in the third stage 606, the clamp member 102 has been further rotated about the pivot component 402. For instance, the angle 610 is smaller than the angle 608. The pivot component 402, for instance, supports rotation of the clamp member 102 from zero to 180 degrees. In this way, the jaw 112 of the clamp member 102 is positionable at a variety of orientations within a plane that includes the longitudinal axis 204.

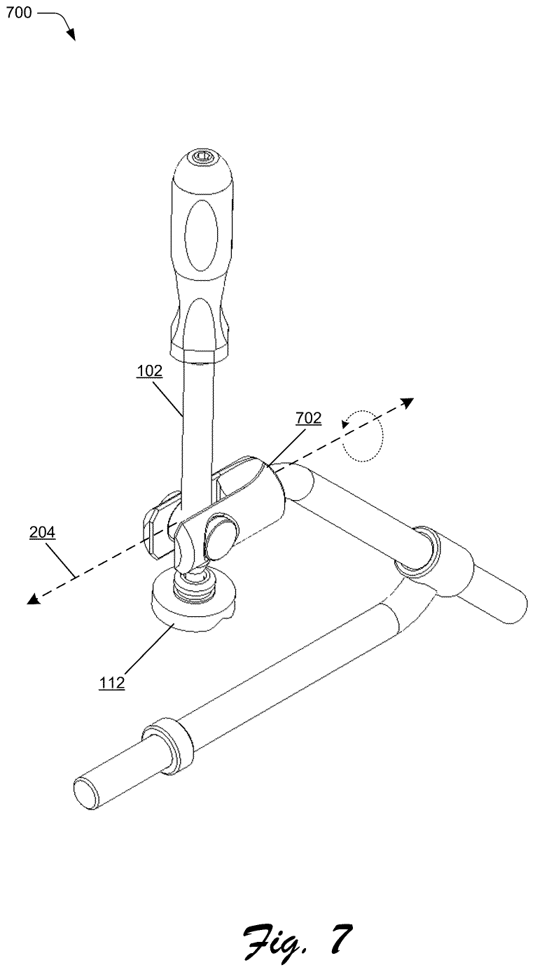

FIG. 7 depicts a view 700 of the angled clamp assembly 100 in an example in which the clamp mounting interface 124 includes a rotational component 702 in accordance with one or more implementations. As described above, in some embodiments the clamp mounting interface 124 further includes a rotational component 702 that enables rotation of the clamp member 102 in one or more planes.

The rotational component 702, for instance, can include one or more bearings, couplings, gears, etc. to support rotation of the clamp member 102. The rotational component 702 may further include one or more mechanisms to fix the clamp member 102 in a desired rotational orientation, such as one or more spring pins and/or perpendicular apertures. By way of example and not limitation, the interface member 104 includes four perpendicular apertures evenly spaced along a circumference of the proximal region 202. The rotational component 702 includes one or more locking spring pins dimensioned to coincide with the perpendicular apertures, such as to lock the rotational component 702 (and thus the clamp member 102) at 90-degree intervals.

In the illustrated example, the rotational component 702 enables rotation of the clamp member 102 about the longitudinal axis 204 of the proximal region 202 of the interface member 104. The rotational component 702, for instance, supports a 360-degree range of motion of the clamp member 102 in a plane perpendicular to the longitudinal axis 204. In this way, the jaw 112 can be positioned at various positions such as to better contact a workpiece.

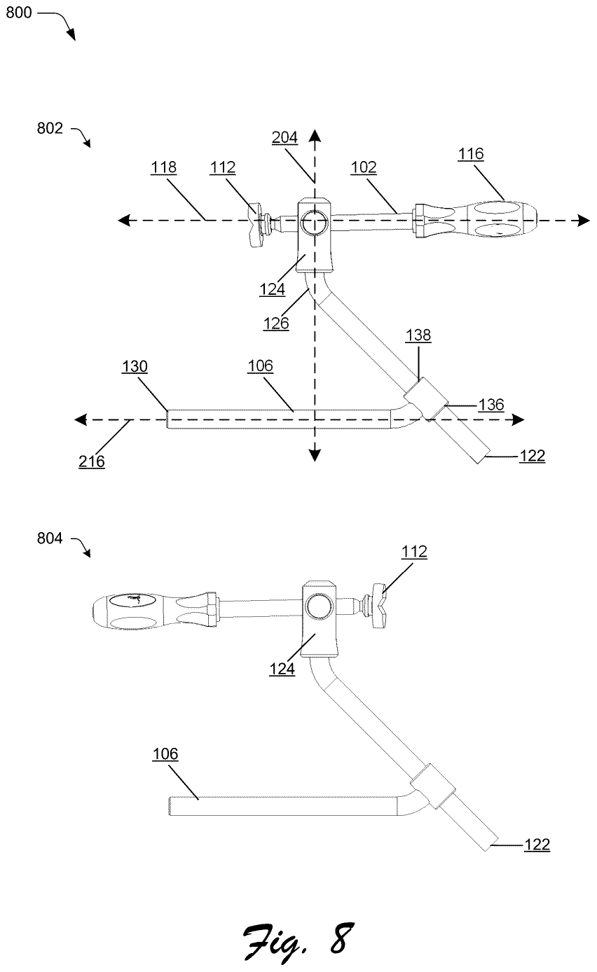

FIG. 8 depicts an example 800 of the angled clamp assembly 100 in which the clamp member 102 is reversible in accordance with one or more implementations in a first stage 802 and a second stage 804. In this example, the support member 106 is configured such that the inner aperture 138 is adjacent to the first bend 126 and the outer aperture 136 is disposed adjacent to the distal end 122. The interface member 104 is further configured such that the longitudinal axis 204 is substantially perpendicular to the longitudinal axis 216 of the distal region 214 of the support member 106. The clamp member 102 is oriented such that the longitudinal axis 118 is substantially parallel to the longitudinal axis 216.

As described above, in various implementations the clamp member 102 is reversible. For instance, one or more of the jaw 112 and/or the actuation component 116 are detachable from the spindle 114 such that the clamp member 102 can be attached to the clamp mounting interface 124. As shown in the first stage 802, the clamp member 102 is disposed in a first direction, such as with the jaw 112 facing a same direction as the distal end 130.

In second stage 804, the clamp member 102 has been reversed. For instance, the actuation component 116 has been removed from the spindle 114, the spindle 114 rotated 180 degrees and inserted through an aperture of the clamp mounting interface 124, and the actuation component 116 reattached. Accordingly, the jaw 112 is facing an opposite direction along the longitudinal axis 118, such that the jaw 112 is facing a same direction as the distal end 122. In this way, the angled clamp assembly 100 provides a modality to quickly and efficiently change a position of the clamp member 102.

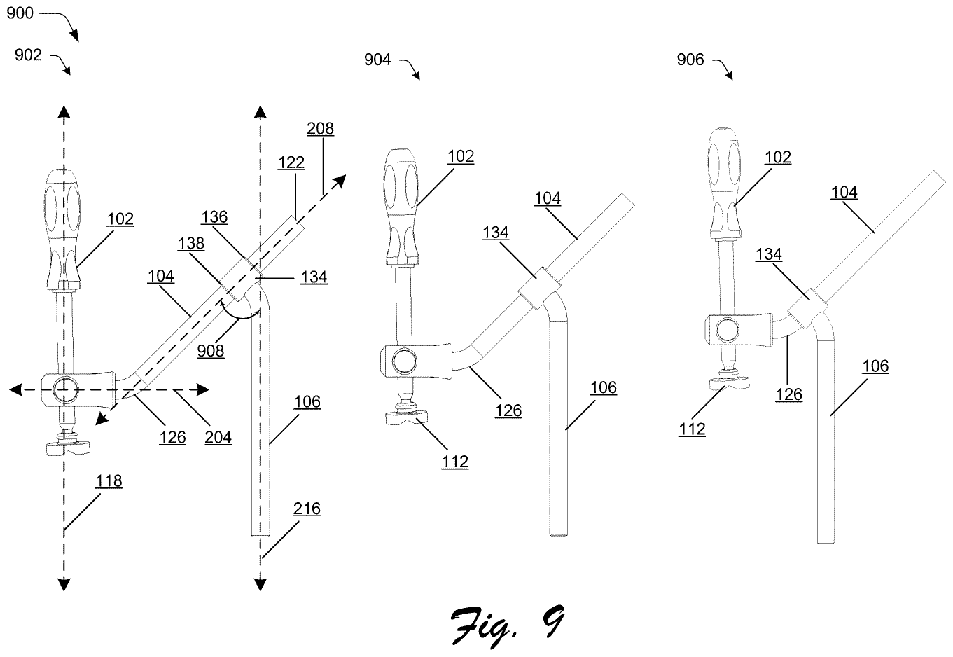

FIG. 9 depicts an example 900 of the angled clamp assembly 100 in which the slidable mounting interface is adjusted in accordance with one or more implementations in a first stage 902, a second stage 904, and a third stage 906. In this example, the inner aperture 138 is disposed adjacent to the first bend 126 such that the longitudinal axis 216 and the longitudinal axis 208 intersect to form an acute interior angle 908. The support member 106 is further rotated such that the longitudinal axis 204 is substantially perpendicular to the longitudinal axis 216 and the clamp member 102 is positioned such that the longitudinal axis 118 is substantially parallel to the longitudinal axis 216.

As depicted in the first stage 902, the support member 106 is positioned at a first location relative to the interface member 104 via the slidable mounting interface 134. For instance, the support member 106 is relatively close to the distal end 122. Progressing to the second stage 904, the slidable mounting interface 134 has been adjusted such as to position the support member 106 at a second location that is relatively closer to the first bend 126 as well relatively closer to the jaw 112. In the third stage 906, the slidable mounting interface 134 has been adjusted again to position the support member 106 at a third location that is relatively closer to the first bend 126. In this way, a location of the jaw 112 relative to the support member 106 as well as a height of the jaw 112 can be controlled via movement of the slidable mounting interface 134 along the longitudinal axis 208.

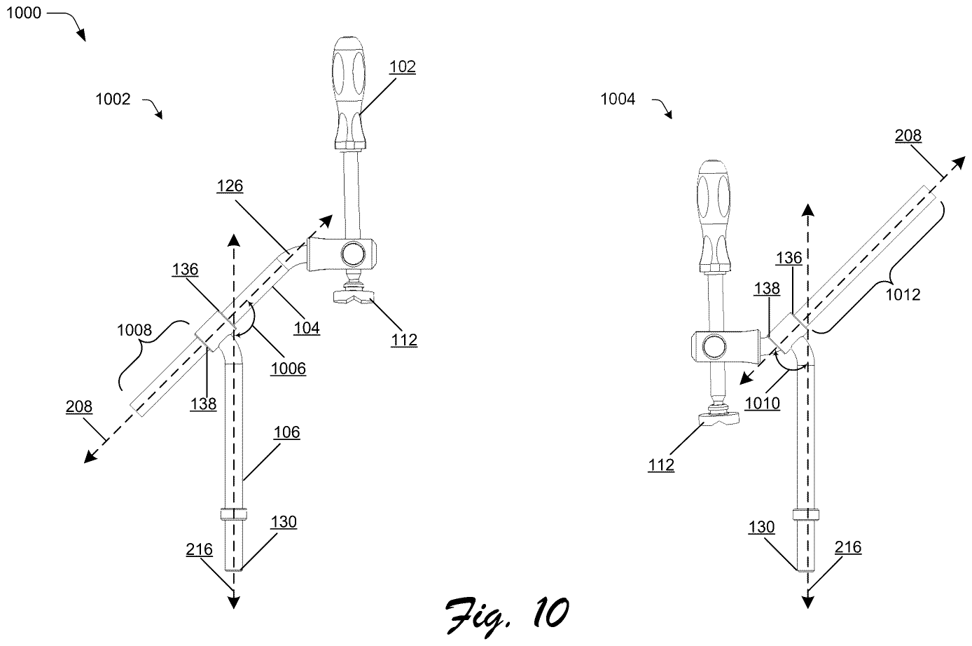

FIG. 10 depicts an example 1000 of the angled clamp assembly 100 in which a position of a tail of the angled clamp assembly 100 is adjusted in accordance with one or more implementations in a first example 1002 and a second example 1004. As shown the first example 1002, the support member 106 is disposed in a first configuration such that the outer aperture 136 is adjacent to the first bend 126. Accordingly, the longitudinal axis 216 and the longitudinal axis 208 intersect to form an obtuse interior angle 1006. Further, in this example the jaw 112 is facing a “downward” direction, e.g., towards distal end 130, such as to apply a downward force to a workpiece when the angled clamp assembly 100 is affixed to an adjacent surface.

In the configuration shown in the first example 1002, the angled clamp assembly 100 further includes a tail region 1008. The tail region 1008, for instance, represents a portion of the interface member 104 disposed between the inner aperture 138 of the slidable mounting interface 134 and the distal end 122. As illustrated, the angled clamp assembly 100 is configured such that the tail region 1008 is “below” the jaw 112. For instance, the tail region 1008 extends in a direction “down and away from” the jaw 112, such as towards the distal end 130 and away from the jaw 112 along the longitudinal axis 208.

As shown in the second example 1004, however, an orientation of the support member 106 relative to the interface member 104 has been adjusted such that the inner aperture 138 is proximal to the first bend 126 and the longitudinal axis 208 and the longitudinal axis 216 intersect to form an acute interior angle 1010. The interface member 104 includes a tail region 1012, e.g., a region of the interface member 104 between the distal end 122 and the outer aperture 136. In this example, the tail region 1012 is “above” the jaw 112. For instance, the tail region 1012 extends in a direction away from the distal end 130 and away from the jaw 112 along the longitudinal axis 208.

In this way, the angled clamp assembly 100 is configurable in a variety of ways to control a footprint of the angled clamp assembly 100 such as to support workspace efficiency. This overcomes the limitations of conventional table clamps that include components that obstruct a workspace and interfere with efforts to apply work to a workpiece. A variety of additional and alternative configurations are considered to control a workspace footprint of the angled clamp assembly 100.

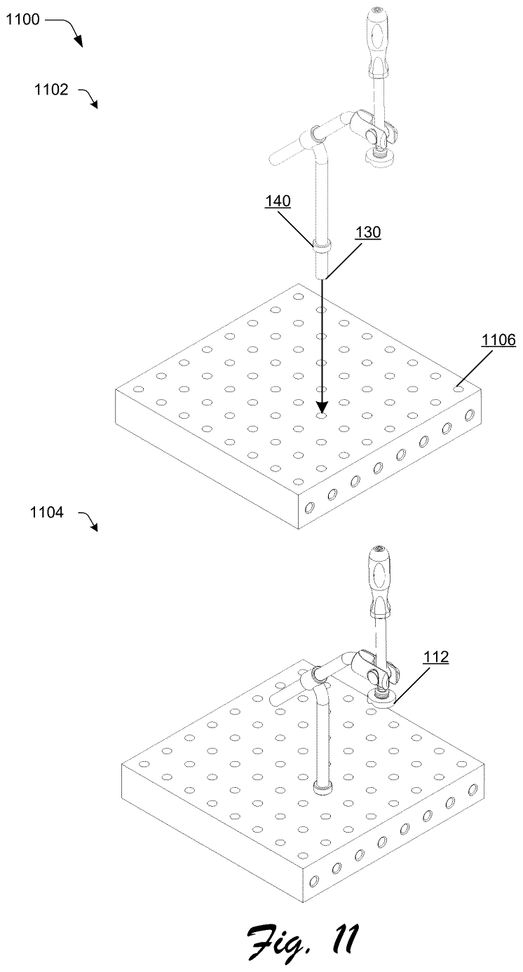

FIG. 11 depicts an example 1100 of the angled clamp assembly 100 in which the angled clamp assembly 100 is attached to a work surface in accordance with one or more implementations in a first stage 1102 and a second stage 1104. In this example, the angled clamp assembly 100 is configured in a particular configuration, such as the first configuration discussed above with respect to FIG. 2.

As shown in the first stage 1102, the angled clamp assembly 100 is positioned above a work surface 1106. The work surface 1106, for instance, includes a gridded configuration of apertures. The distal end 130 of the support member 106 is dimensioned to coincide with an aperture of the work surface 1106.

For instance, as shown in the second stage 1104, the angled clamp assembly 100 is inserted into an aperture of the work surface 1106. In accordance with the techniques described above, the collar 140 controls a depth of insertion of the support member 106 into the aperture. Accordingly, in this particular configuration of the angled clamp assembly 100, the jaw 112 can apply downward force, such as to secure a workpiece between the jaw 112 and the work surface 1106.

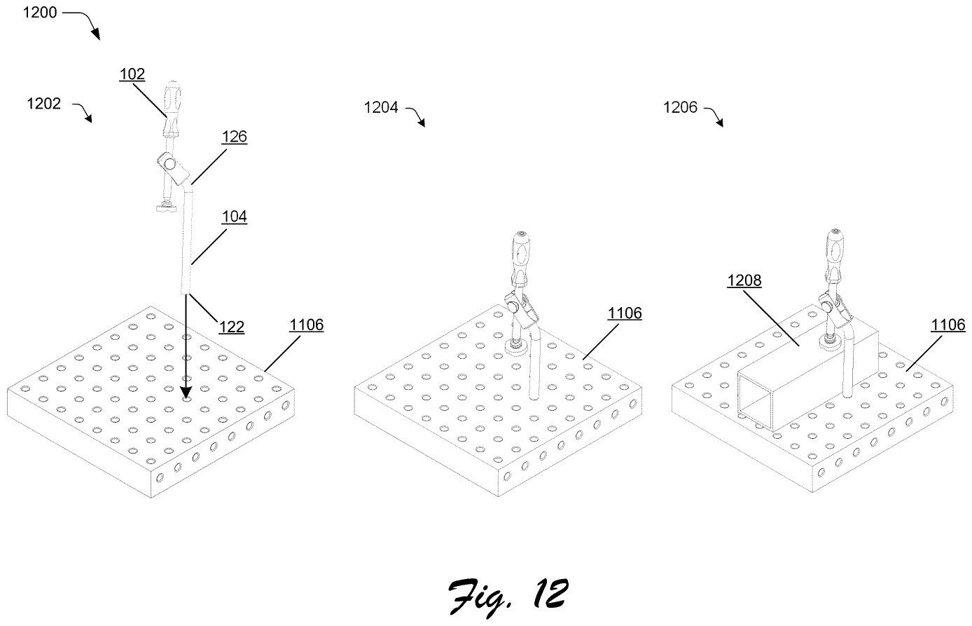

FIG. 12 depicts an example 1200 of the angled clamp assembly 100 in which the interface member 104 is insertable into a work surface in accordance with one or more implementations in a first stage 1202, a second stage 1204, and a third stage 1206. In the example 1200, an angled clamp component of the angled clamp assembly 100 includes the clamp member 102 and the interface member 104. For instance, the interface member 104 and the clamp member 102 are operable independent of the support member 106. For example, inclusion of the first bend 126 in the interface member 104 positions the clamp member 102 an offset distance from the interface member 104 and enables the jaw 112 of the clamp member 102 to face downward, such as to provide a downward force to a workpiece, without impediment from the support member 106.

As depicted in the first stage 1202, the angled clamp assembly 100 includes an angled clamp component including the clamp member 102 and the interface member 104 that is disposed above a work surface 1106. The distal end 122 of the interface member 104 is dimensioned to coincide with the apertures of the work surface 1106. As shown in the second stage 1204, the distal end 122 is inserted into an aperture of the work surface 1106. In some examples, the interface member 104 is fitted with a collar such as the collar 140 to control a depth of insertion into the aperture of the work surface 1106.

As shown in the third stage third stage 1206, the angled clamp assembly 100 is operable to clamp a workpiece 1208 between the jaw 112 and the work surface 1106. Because of the inclusion of the first bend 126, the clamp member 102 is offset by a distance from the longitudinal axis 208, and thus has a range of motion capable of providing a downward force independent of an additional member, e.g., the support member 106, which is not possible using conventional clamps. In this way, the techniques described herein further reduce a tool footprint of the angled clamp assembly 100. Accordingly, the techniques described herein provide for a variety of implementation scenarios and use cases.

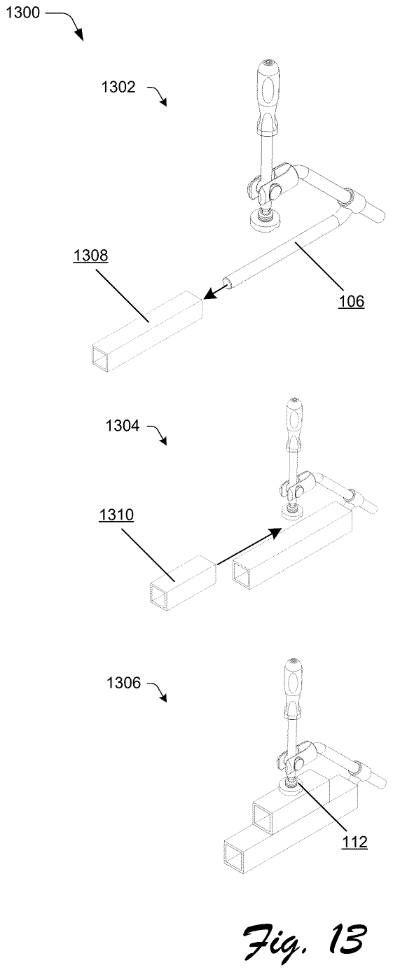

FIG. 13 depicts an example 1300 of the angled clamp assembly 100 in which the angled clamp assembly 100 is operable to affix two work pieces to one another in accordance with one or more implementations in a first stage 1302, a second stage 1304, and a third stage 1306. In this example, the angled clamp assembly 100 is disposed in a particular configuration, such as the second configuration described above with respect to FIG. 3. In this example, the collar 140 has further been removed from the support member 106.

As shown in the first stage 1302, the support member 106 is dimensioned to be inserted into a first workpiece 1308. As shown in the second stage 1304, the support member 106 has been inserted into the first workpiece 1308, and a user desires to clamp a second workpiece 1310 to the first workpiece 1308, such as to apply work to one or more of the first workpiece 1308 and/or the second workpiece 1310. As shown in the third stage 1306, the second workpiece 1310 is secured between the jaw 112 and the first workpiece 1308. Thus, the techniques described herein provide a variety of functionality usable for a variety of scenarios.

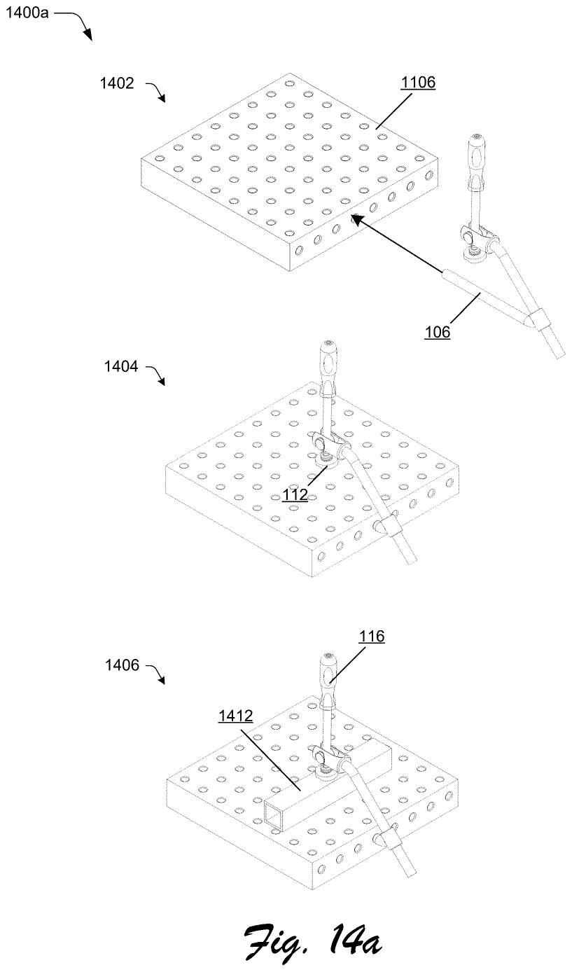

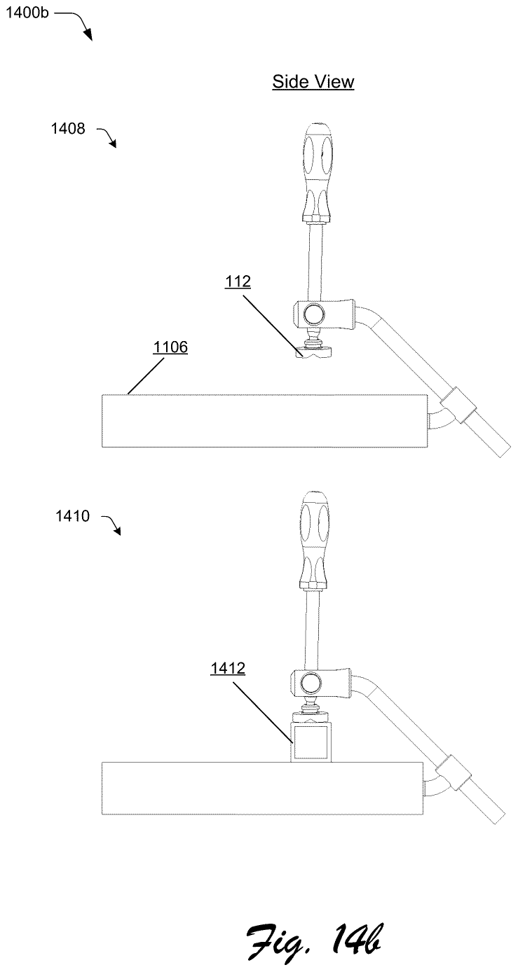

FIGS. 14a and 14b depict an example 1400a, 1400b of the angled clamp assembly 100 in which the angled clamp assembly 100 is insertable into a side aperture of a work surface in accordance with one or more implementations. FIG. 14a, for instance, depicts the example 1400a in a first stage 1402, a second stage 1404, and a third stage 1406. FIG. 14b, for instance, is an example 1400b depicting a first side view 1408 and a second side view 1410 of the example shown in FIG. 14a.

As shown in the first stage 1402, the work surface 1106 includes a variety of perpendicular apertures located on a side surface of the work surface 1106. The angled clamp assembly 100 in this example is disposed adjacent to the work surface 1106 in a particular configuration, such as the configuration described above with respect to FIG. 3. The support member 106 in this example further does not include a collar 140, however this is by way of example and not limitation.

As shown in the second stage 1404, the support member 106 is inserted into one of the side apertures of the work surface 1106. Accordingly, the jaw 112 is positionable in a plane parallel to and above the work surface 1106. In the third stage 1406, the angled clamp assembly 100 is used to secure a workpiece 1412 to the work surface 1106. For instance, the workpiece 1412 is positioned between the jaw 112 and the work surface 1106. The actuation component 116 is actuated to cause the jaw 112 to provide downward force to secure the workpiece 1412.

This is further depicted in the first side view 1408 and the second side view 1410. For instance, the first side view 1408 depicts the angled clamp assembly 100 as inserted into the work surface 1106 with the jaw 112 positioned above the surface of the work surface 1106. The second side view 1410 depicts the workpiece 1412 secured between the work surface 1106 and the jaw 112.

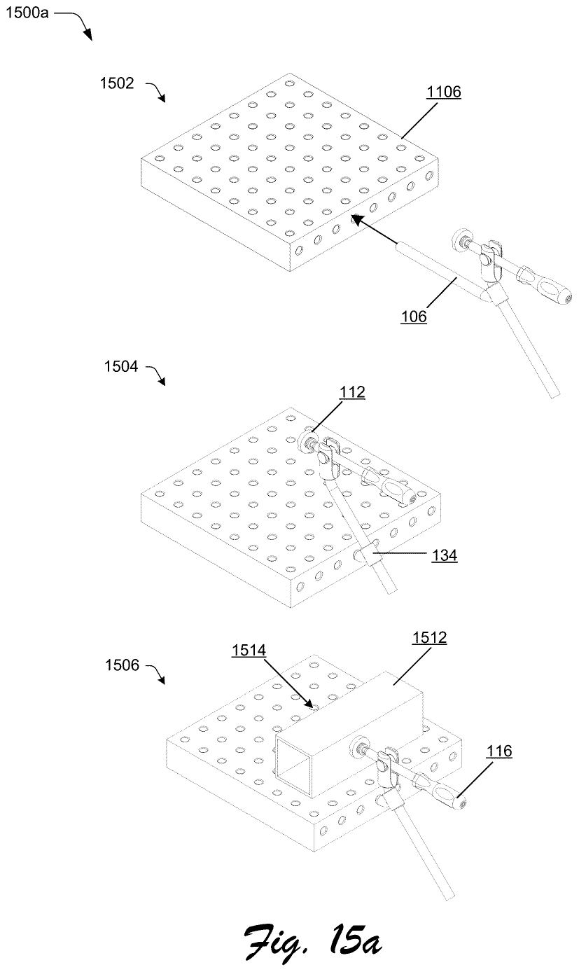

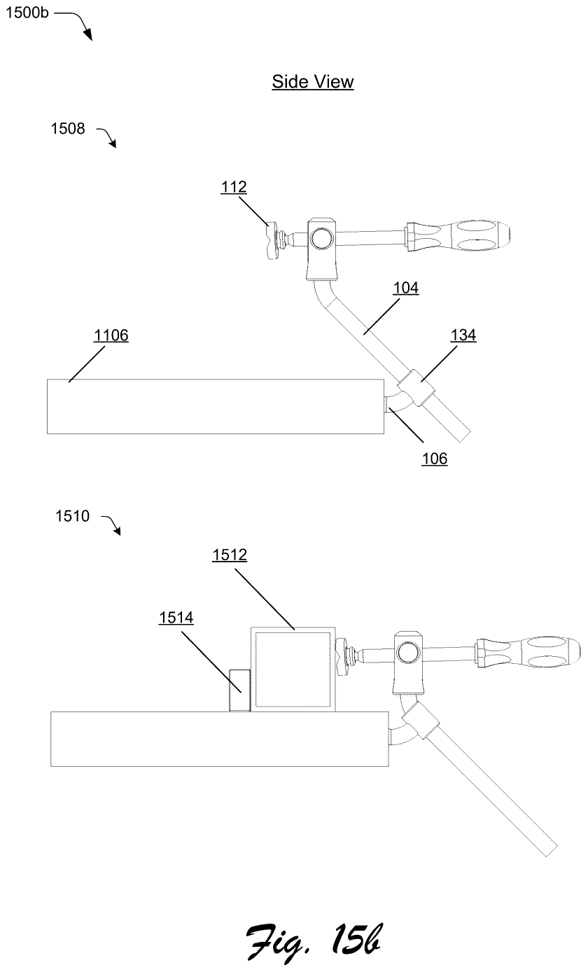

FIGS. 15a and 15b depict an example 1500a, 1500b of the angled clamp assembly 100 in which the angled clamp assembly 100 is insertable into a side aperture of a work surface in accordance with one or more implementations. FIG. 15a, for instance, depicts the example 1500a in a first stage 1502, a second stage 1504, and a third stage 1506. FIG. 15b, for instance, is an example 1500b depicting a first side view 1508 and a second side view 1510 of the example shown in FIG. 15a.

As shown in the first stage 1502, the angled clamp assembly 100 is disposed adjacent to a perpendicular aperture of the work surface 1106 in a particular configuration. The angled clamp assembly 100, for instance, has the configuration as described above in the second example 1004 of FIG. 10, e.g., with a tail up and away from the jaw 112. The support member 106 in this example further does not include a collar 140, however this is by way of example and not limitation.

As shown in the second stage 1504, the support member 106 is inserted into one of the side apertures of the work surface 1106. Accordingly, the jaw 112 is positionable in a plane perpendicular to the work surface 1106. In the third stage 1506, the angled clamp assembly 100 is used to secure a workpiece. For instance, the workpiece 1512 is positioned between the jaw 112 and a fence block component 1514, which is depicted in the second side view 1510. The fence block component 1514, for instance, is affixed to the work surface 1106, such as to provide a surface for which the jaw 112 can clamp objects against. A position of the jaw 112 is adjusted to a desirable position such as by sliding the interface member 104 via the slidable mounting interface 134. The actuation component 116 is then actuated to cause the jaw 112 to provide a sideways force to secure the workpiece 1512 between the jaw 112 and the fence block component 1514.

This is further depicted in the first side view 1508 and the second side view 1510. For instance, the first side view 1508 depicts the angled clamp assembly 100 as inserted into the work surface 1106 with the jaw 112 in a first position in a plane perpendicular to the work surface 1106. The second side view 1510 depicts the jaw 112 in a second position, such as by adjusting a position of the interface member 104 relative to the support member 106 via the slidable mounting interface 134. The second side view 1510 further depicts the workpiece 1512 secured between the jaw 112 and the fence block component 1514. Thus, the techniques, components, and assemblies described herein are usable in a variety of configurations and orientations to achieve a variety of functionality not possible using conventional clamps.

Generally, the various structures and features discussed herein such as the modular angled clamp assemblies and components are combinable in various ways including implementations not expressly illustrated herein to provide for a variety of different modular angled clamp assemblies and components.

### Conclusion

Accordingly, modular angled clamp assemblies, components, and techniques associated with modular angled clamp assemblies are described. The modular angled clamp assemblies are usable to ensure precise and secure positioning of various workpieces while providing access for performing attachment and/or other work techniques thereon, which is not possible using conventional tools and techniques.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention. Additional aspects of the techniques, features, and/or methods discussed herein relate to one or more of the following:

In some aspects, the techniques described herein relate to an angled clamp assembly including: an interface member including a first bend disposed between a proximal end and a distal end of the interface member, a distal region between the first bend and the distal end of the interface member, and a proximal region between the first bend and the proximal end of the interface member, the proximal end of the interface member including a clamp mounting interface; a support member including a second bend disposed between a proximal end and a distal end of the support member, a distal region between the second bend and the distal end of the support member, and a proximal region between the second bend and the proximal end of the support member, the proximal end of the interface member including a slidable mounting interface to adjustably connect the proximal end of the support member to the distal region of the interface member; and a clamp member rotatably attached to the interface member via the clamp mounting interface and including a proximal end and a distal end, the proximal end of the clamp member including a jaw, the distal end including an actuation component to control a position of the jaw along a longitudinal axis of the clamp member.

In some aspects, the techniques described herein relate to an angled clamp assembly, wherein the first bend has a first bend angle in a range of 40 and 50 degrees and the second bend has a second bend angle in a range of 40 and 50 degrees.

In some aspects, the techniques described herein relate to an angled clamp assembly, wherein the clamp mounting interface includes a pivot component attached to the clamp member between the proximal end of the clamp member and the distal end of the clamp member, the clamp member rotatable about the pivot component in a plane that includes a longitudinal axis of the proximal region of the interface member.

In some aspects, the techniques described herein relate to an angled clamp assembly, wherein the clamp mounting interface further includes a rotational component and the clamp member is rotatable about the longitudinal axis of the proximal region of the interface member via the rotational component.

In some aspects, the techniques described herein relate to an angled clamp assembly, wherein the support member is attached to the interface member in a first orientation via the slidable mounting interface to achieve a first configuration of the angled clamp assembly, the slidable mounting interface reversible to attach the support member to the interface member in a second orientation to achieve a second configuration of the angled clamp assembly.

In some aspects, the techniques described herein relate to an angled clamp assembly, wherein in the first configuration a longitudinal axis of the distal region of the interface member is substantially perpendicular to a longitudinal axis of the proximal region of the support member, and the clamp member is positionable such that a longitudinal axis of the clamp member is substantially parallel to a longitudinal axis of the distal region of the support member.

In some aspects, the techniques described herein relate to an angled clamp assembly, wherein in the second configuration a longitudinal axis of the distal region of the interface member is substantially perpendicular to a longitudinal axis of the proximal region of the support member, and the clamp member is positionable such that a longitudinal axis of the clamp member is substantially perpendicular to a longitudinal axis of the distal region of the support member.

In some aspects, the techniques described herein relate to an angled clamp assembly, wherein the support member includes a removable collar to control a depth of insertion of the proximal end of the support member into an aperture of an adjacent surface.

In some aspects, the techniques described herein relate to an angled clamp assembly, wherein the clamp member includes a threaded region and the clamp mounting interface includes an aperture with double-entry threads that correspond to the threaded region such that the clamp member is reversible within the aperture.

In some aspects, the techniques described herein relate to an angled clamp assembly including: an interface member including a proximal end and a distal end, a first bend disposed between of the proximal end and the distal end of the interface member, a distal region between the first bend and the distal end of the interface member, and a proximal region between the first bend and the proximal end of the interface member, the proximal end of the interface member including a clamp mounting interface attachable to a clamp member; and a support member including a proximal end and a distal end, a second bend disposed between the proximal end and the distal end of the support member, a distal region between the second bend and the distal end of the support member, and a proximal region between the second bend and the proximal end of the support member, the proximal end of the interface member including a slidable mounting interface to adjustably connect the support member to the distal region of the interface member in a first configuration, the slidable mounting interface reversible to connect the support member to the distal region of the interface member in a second configuration.

In some aspects, the techniques described herein relate to an angled clamp assembly, wherein in the first configuration a longitudinal axis of the distal region of the support member forms an obtuse interior angle with a longitudinal axis of the distal region of the interface member, and in the second configuration the longitudinal axis of the distal region of the support member forms an acute interior angle with the longitudinal axis of the distal region of the interface member.

In some aspects, the techniques described herein relate to an angled clamp assembly, wherein the clamp member includes a proximal end and a distal end, the proximal end of the clamp member including a jaw, the distal end of the clamp member including an actuation component to control a position of the jaw along a longitudinal axis of the clamp member, the clamp member rotatably attached to the interface member via the clamp mounting interface at a location between the proximal end and the distal end of the clamp member.

In some aspects, the techniques described herein relate to an angled clamp assembly, wherein in the first configuration the jaw is positionable in a plane substantially perpendicular to a longitudinal axis of the distal region of the support member.

In some aspects, the techniques described herein relate to an angled clamp assembly, wherein in the second configuration, the jaw is positionable in a plane substantially parallel to a longitudinal axis of the distal region of the support member.

In some aspects, the techniques described herein relate to an angled clamp assembly, wherein the first bend has a first bend angle in a range of 40 and 50 degrees and the second bend has a second bend angle in a range of 40 and 50 degrees.

In some aspects, the techniques described herein relate to an angled clamp assembly, wherein the clamp mounting interface includes a pivot component and a rotational component, the clamp member rotatable about the pivot component in a plane that includes a longitudinal axis of the proximal region of the interface member, the clamp member further rotatable about the longitudinal axis of the proximal region of the interface member via the rotational component.

In some aspects, the techniques described herein relate to an angled clamp component including: an interface member including: a bend disposed between a proximal end and a distal end of the interface member; a distal region between the bend and the distal end of the interface member; and a proximal region between the bend and the proximal end of the interface member, the proximal end of the interface member including a clamp mounting interface; and a clamp member rotatably attached to the interface member via the clamp mounting interface and including a proximal end and a distal end, the proximal end of the clamp member including a jaw, the distal end including an actuation component to control a position of the jaw along a longitudinal axis of the clamp member.

In some aspects, the techniques described herein relate to an angled clamp component, wherein the bend has a bend angle in a range of 40 and 50 degrees such that a longitudinal axis of the distal region and a longitudinal axis of the proximal region intersect to form an angle in a range of 130 and 140 degrees.

In some aspects, the techniques described herein relate to an angled clamp component, wherein the clamp mounting interface includes a pivot component attached to the clamp member between the proximal end of the clamp member and the distal end of the clamp member, the clamp member rotatable about the pivot component in a plane that includes a longitudinal axis of the proximal region of the interface member.

In some aspects, the techniques described herein relate to an angled clamp component, wherein the clamp mounting interface further includes a rotational component, and the clamp member is rotatable about the longitudinal axis of the proximal region of the interface member via the rotational component.

What is claimed is:

1. An angled clamp assembly comprising:
an interface member including a first bend disposed between a proximal end and a distal end of the interface member, a distal region between the first bend and the distal end of the interface member, and a proximal region between the first bend and the proximal end of the interface member, the proximal end of the interface member including a clamp mounting interface;
a support member including a second bend disposed between a proximal end and a distal end of the support member, a distal region between the second bend and the distal end of the support member, and a proximal region between the second bend and the proximal end of the support member, the proximal end of the interface member including a slidable mounting interface to adjustably connect the proximal end of the support member to the distal region of the interface member; and
a clamp member rotatably attached to the interface member via the clamp mounting interface and including a proximal end and a distal end, the proximal end of the clamp member including a jaw, the distal end including an actuation component to control a position of the jaw along a longitudinal axis of the clamp member.

2. The angled clamp assembly as described in claim 1, wherein the first bend has a first bend angle in a range of 40 and 50 degrees and the second bend has a second bend angle in a range of 40 and 50 degrees.

3. The angled clamp assembly as described in claim 1, wherein the clamp mounting interface includes a pivot component attached to the clamp member between the proximal end of the clamp member and the distal end of the clamp member, the clamp member rotatable about the pivot component in a plane that includes a longitudinal axis of the proximal region of the interface member.

4. The angled clamp assembly as described in claim 3, wherein the clamp mounting interface further includes a rotational component and the clamp member is rotatable about the longitudinal axis of the proximal region of the interface member via the rotational component.

5. The angled clamp assembly as described in claim 1, wherein the support member is attached to the interface member in a first orientation via the slidable mounting interface to achieve a first configuration of the angled clamp assembly, the slidable mounting interface reversible to attach the support member to the interface member in a second orientation to achieve a second configuration of the angled clamp assembly.

6. The angled clamp assembly as described in claim 5, wherein in the first configuration a longitudinal axis of the distal region of the interface member is substantially perpendicular to a longitudinal axis of the proximal region of the support member, and the clamp member is positionable such that a longitudinal axis of the clamp member is substantially parallel to a longitudinal axis of the distal region of the support member.

7. The angled clamp assembly as described in claim 5, wherein in the second configuration a longitudinal axis of the distal region of the interface member is substantially perpendicular to a longitudinal axis of the proximal region of the support member, and the clamp member is positionable such that a longitudinal axis of the clamp member is substantially perpendicular to a longitudinal axis of the distal region of the support member.

8. The angled clamp assembly as described in claim 1, wherein the support member includes a removable collar to control a depth of insertion of the proximal end of the support member into an aperture of an adjacent surface.

9. The angled clamp assembly as described in claim 1, wherein the clamp member includes a threaded region and the clamp mounting interface includes an aperture with double-entry threads that correspond to the threaded region such that the clamp member is reversible within the aperture.

10. An angled clamp assembly comprising:
an interface member including a proximal end and a distal end, a first bend disposed between of the proximal end and the distal end of the interface member, a distal region between the first bend and the distal end of the interface member, and a proximal region between the first bend and the proximal end of the interface member, the proximal end of the interface member including a clamp mounting interface attachable to a clamp member; and
a support member including a proximal end and a distal end, a second bend disposed between the proximal end and the distal end of the support member, a distal region between the second bend and the distal end of the support member, and a proximal region between the second bend and the proximal end of the support member, the proximal end of the interface member including a slidable mounting interface to adjustably connect the support member to the distal region of the interface member in a first configuration, the slidable mounting interface reversible to connect the support member to the distal region of the interface member in a second configuration.

11. The angled clamp assembly as described in claim 10, wherein in the first configuration a longitudinal axis of the distal region of the support member forms an obtuse interior angle with a longitudinal axis of the distal region of the interface member, and in the second configuration the longitudinal axis of the distal region of the support member forms an acute interior angle with the longitudinal axis of the distal region of the interface member.

12. The angled clamp assembly as described in claim 10, wherein the clamp member includes a proximal end and a distal end, the proximal end of the clamp member including a jaw, the distal end of the clamp member including an actuation component to control a position of the jaw along a longitudinal axis of the clamp member, the clamp member rotatably attached to the interface member via the clamp mounting interface at a location between the proximal end and the distal end of the clamp member.

13. The angled clamp assembly as described in claim 12, wherein in the first configuration the jaw is positionable in a plane substantially perpendicular to a longitudinal axis of the distal region of the support member.

14. The angled clamp assembly as described in claim 12, wherein in the second configuration, the jaw is positionable in a plane substantially parallel to a longitudinal axis of the distal region of the support member.

15. The angled clamp assembly as described in claim 10, wherein the first bend has a first bend angle in a range of 40 and 50 degrees and the second bend has a second bend angle in a range of 40 and 50 degrees.

16. The angled clamp assembly as described in claim 10, wherein the clamp mounting interface includes a pivot component and a rotational component, the clamp member rotatable about the pivot component in a plane that includes a longitudinal axis of the proximal region of the interface member, the clamp member further rotatable about the longitudinal axis of the proximal region of the interface member via the rotational component.

17. An angled clamp component comprising:
an interface member including:
a bend disposed between a proximal end and a distal end of the interface member;
a distal region between the bend and the distal end of the interface member; and
a proximal region between the bend and the proximal end of the interface member, the proximal end of the interface member including a clamp mounting interface; and
a clamp member rotatably attached to the interface member via the clamp mounting interface and including a proximal end and a distal end, the proximal end of the clamp member including a jaw, the distal end including an actuation component to control a position of the jaw along a longitudinal axis of the clamp member.

18. The angled clamp component as described in claim 17, wherein the bend has a bend angle in a range of 40 and 50 degrees such that a longitudinal axis of the distal region and a longitudinal axis of the proximal region intersect to form an angle in a range of 130 and 140 degrees.

19. The angled clamp component as described in claim 17, wherein the clamp mounting interface includes a pivot component attached to the clamp member between the proximal end of the clamp member and the distal end of the clamp member, the clamp member rotatable about the pivot component in a plane that includes a longitudinal axis of the proximal region of the interface member.

20. The angled clamp component as described in claim 19, wherein the clamp mounting interface further includes a rotational component, and the clamp member is rotatable about the longitudinal axis of the proximal region of the interface member via the rotational component.
